(19) United States
(12) Patent Application Publication
(10) Pub. No.: US 2010/0161405 A1
(43) Pub. Date: Jun. 24, 2010

(54) CUSTOM SETTLEMENT ARRANGEMENTS

(76) Inventors: Karen L. Cervenka, Belmont, CA (US); Mary Theresa Taylor, San Francisco, CA (US); Millie Yee, Santa Clara, CA (US); Bonnie Vail, San Marcos, CA (US)

Correspondence Address: Quarles & Brady LLP, TWO NORTH CENTRAL AVENUE, One Renaissance Square, PHOENIX, AZ, 85004-2391, US

(21) Appl. No.: 12/630,456

(22) Filed: Dec. 3, 2009

Related U.S. Application Data
(60) Provisional application No. 61/120,417, filed on Dec. 6, 2008.

(51) Int. Cl. G06Q 20/00; G06Q 40/00; G06Q 30/00

(52) U.S. Cl. 705/14.38; 705/44

(57) ABSTRACT

Processing transactions involving private label portable consumer devices is presented. For a transaction involving a portable consumer device in a payment processing network, an authorization request from a merchant is received by a transaction handler. The transaction handler, in communication with the issuer, denies or approves the transaction. For approved transactions, the merchant sends a settlement request to the transaction handler. If the transaction is identified as involving a private label portable consumer device, the transaction handler applies a custom settlement arrangement rate to the payment sought, generally reducing the payment amount. The applied payment amount is received from the issuer and forwarded to the merchant. If the applied payment amount is less than the actual amount owed to the merchant, the merchant sends a request to the issuer of the private label payment device to settle the transaction in accordance with a custom settlement agreement.

### CROSS-REFERENCE TO RELATED APPLICATIONS

This application claims priority to, and the benefit of, U.S. Provisional Application Ser. No. 61/120,417, filed on Dec. 6, 2008, titled “Custom Settlement Arrangements,” which is incorporated herein by reference.

### BACKGROUND

The present invention relates generally to the processing of transactions on accounts respectively corresponding to portable consumer devices, where the processing occurs in a payment processing network. More particularly, the processing of such transactions involves moving funds for each such transaction outside of the payment processing network.

A private label portable consumer device is a portable consumer device, such as, for example, a prepaid card, credit card, or gift card, that does not carry the logo of a major network such as Visa, MasterCard, Discover, or American Express. Instead, private label cards typically carry only a merchant logo and are limited to transactions with that merchant. Unlike major network portable consumer devices, private label portable consumer devices involve a special custom settlement arrangement dictating the terms of use between the issuer of the device and the merchant who's logo is on it, limiting the ability of existing payment processing networks to accept private label portable consumer devices. Examples of such customized settlement arrangements include the issuer negotiating with the merchant for a discounted rate for a particular product, where the cardholder pays the full price and the discount is applied during settlement between the merchant and issuer. Alternatively, the cardholder may receive the discount with the merchant and issuer later splitting the cost of the discount in some manner.

Currently, payment processing networks cannot handle private label card programs having customized settlement arrangements where the transfer of funds between the issuer and merchant occur outside these payment processing networks. The authorization of a transaction, without submitting it into a clearing and settlement process where funds would be exchanged, requires operational and/or system changes at the merchant's point-of-sale terminals (POS). These changes are cost prohibitive to implementing most private label card programs. It is desirable for private label card programs, having customized settlement arrangements between the issuer and merchants, to be able to use these cards at the merchant's point-of-sale terminals (POS).

It would be an advantage to support transactions on accounts corresponding to private label cards within an existing payment processing network, where the actual movement of funds for each transaction occurs outside the payment processing network but does not require a change at the POS at which the transaction took place.

### SUMMARY

In one implementation, an authorization request for a transaction in a payment processing network is received and a transmission is addressed for delivery, the transmission including a response either denying or approving the transaction. For transactions that are approved, a settlement request for the transaction is received. If the transaction meets criteria identifying the transaction as involving a private label portable consumer device, a custom settlement arrangement rate is applied to the settlement request. Lastly, another transmission is addressed for delivery, the transmission including a settlement response to the applied settlement request.

In another implementation, an authorization request for a transaction in a payment processing network is received and a transmission is addressed for delivery, the transmission including a response either denying or approving the transaction. For transactions that are approved, a settlement request, including a payment amount for the transaction, is received. If the transaction meets criteria identifying the transaction as involving a private label portable consumer device, a custom settlement arrangement rate is applied to the payment amount sought in the settlement request to determine a custom settlement amount. The custom settlement amount is debited from an account issued by an issuer and another transmission is addressed for delivery including a credit for the custom settlement amount.

In yet another implementation, a criteria for applying a custom settlement arrangement rate to a transaction is received from an issuer and the criteria and custom settlement arrangement rate is stored in a table containing other criteria corresponding to other custom settlement arrangement rates. Next, an authorization request for a transaction in a payment processing network is received and a transmission is addressed for delivery, the transmission including a response either denying or approving the transaction. For transactions that are approved, a settlement request, including transaction data and a payment amount, is received. If the transaction data meets criteria identifying the transaction as involving a private label portable consumer device, a custom settlement arrangement rate is applied to the payment amount sought in the settlement request to determine a custom settlement amount. The custom settlement amount is debited from an account issued by an issuer and another transmission is addressed for delivery including a credit for the custom settlement amount.

In an additional implementation, a transmission, including an authorization request for a transaction in a payment processing network, is addressed for delivery and an authorization response is received, the authorization response either denying or approving the transaction. For transactions that are approved, another transaction is addressed for delivery, the transaction including a settlement request. If the transaction meets criteria identifying the transaction as involving a private label portable consumer device, a settlement response is received where a custom settlement arrangement rate was applied to the settlement request.

Yet another implementation occurs in a payment processing system, where a transaction handler processes multiple transactions characterized by a merchant and a consumer engaging in the transaction upon an account associated with an account for a payment device that an issuer issues to the consumer. In this implementation, the payment processing system includes both an open loop network and a closed loop network. In the open loop network, the merchant submits the transaction for processing by the transaction handler. The transaction handler requests the issuer of the account upon with the transaction was conducted to obtain payment for the transaction. The issuer forwards the payment to the transaction handler who forwards it to the acquirer to pay the merchant. In the closed loop network, the merchant submits a settlement request to the issuer requesting the issuer obtain payment for the transaction from the account issued by the issuer. The issuer forwards the payment to the merchant. Here, there is an existing custom settlement arrangement between the issuer and merchant that defines conditions for payment of the transaction. The merchant then submits the transaction to the open loop network, wherein, if it meets a predetermined criteria identifying the transaction as involving a private label portable consumer device, the transaction handler applies a custom arrangement rate to the payment requested from the issuer to derived an applied payment. The applied payment is forwarded from the issuer to the transaction handler who forwards it to the acquirer to pay the merchant. If the transaction meets the conditions for payment defined in the custom settlement arrangement, the merchant then submits a settlement request to the issuer to obtain (from the account upon which the transaction was conducted) a payment for any amount still owed to the merchant.

### BRIEF DESCRIPTION OF THE DRAWINGS

Implementations of the invention will become more apparent from the detailed description set forth below when taken in conjunction with the drawings, in which like elements bear like reference numerals.

FIG. 1 illustrates an exemplary payment processing network;

FIG. 2 depicts a flowchart of an exemplary process flow for the authorization of a purchase using a private label portable consumer device;

FIG. 3 depicts a flowchart of an exemplary process flow for the clearing and settlement of a purchase made using a private label portable consumer device;

FIG. 4 illustrates an exemplary payment processing network using the methods described in FIGS. 2 and 3.

FIG. 5 depicts an exemplary process for a particular financial transaction system in which the methods described in FIGS. 2 and 3 can be used, having various components as illustrated, in which there is a provision of a service by a merchant to a consumer in authorizing and remunerating electronic payment by an account holder in conducting a financial transaction on an account with the merchant (i.e.; a credit card transaction).

FIG. 6 illustrates systems housed within an interchange center to provide online and offline transaction processing; and

FIG. 7 illustrates another view of the components of FIG. 5.

### DETAILED DESCRIPTION

The present discussion considers processing, in a payment processing system, transactions conducted on an account corresponding to a private label portable consumer device. Specifically, a private label portable consumer device is a portable consumer device, such as, for example, a prepaid card, credit card, or gift card, that does not carry the logo of a major network such as Visa, MasterCard, Discover, or American Express. Instead, private label cards typically only carry a merchant logo and are limited to transactions with that merchant. Unlike major network portable consumer devices, private label portable consumer devices involve a special custom settlement arrangement dictating the terms of use between the issuer of the device and the merchant who's logo is on it.

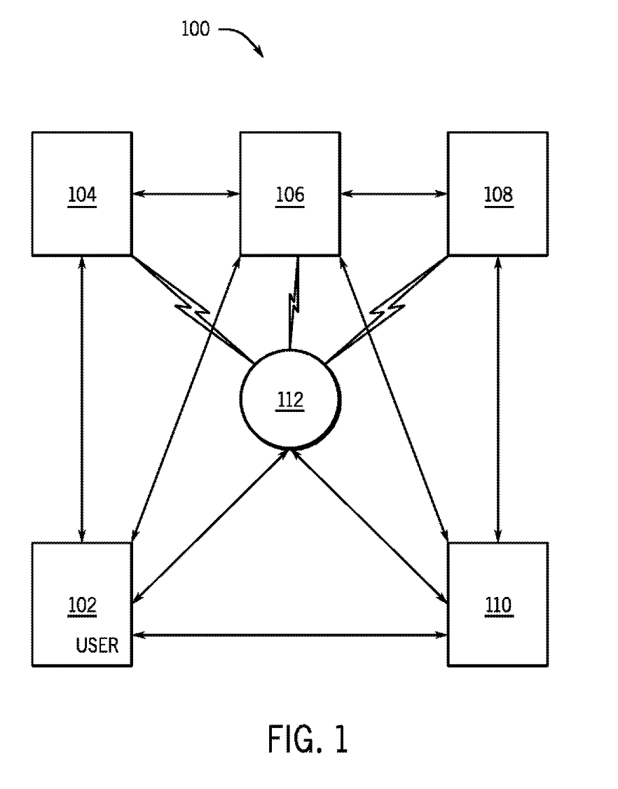

FIG. 1 illustrates an exemplary payment processing system. In general, a transaction includes participation from different entities that are a component of a payment processing system 100, including an user 102, such as an account holder (e.g.; the consumer associated with the account), a transaction handler 106, such as a credit card company, an acquirer 108, a merchant 110, and an issuer 104. Acquirer 108 and issuer 104 can communicate through transaction handler 106. Merchant 110 may be a person or entity that sells goods or services. Merchant 110 may also be, for instance, a manufacturer, a distributor, a retailer, a load agent, a drugstore, a grocery store, a gas station, a hardware store, a supermarket, a boutique, a restaurant, or a doctor's office. In a business-to-business setting, the user 102 may be a second merchant making a purchase from another merchant 110. Merchant 110 may utilize at least one point-of-sale terminal (POS) that can communicate with acquirer 108, transaction handler 106, or issuer 104. Thus, the POS terminal is in operative communication with the payment processing system 100.

Typically, a transaction begins with user 102, such as an account holder or a consumer, presenting a portable consumer device 112 to merchant 110 to initiate an exchange for a good or service. The portable consumer device 112 may include a payment card, a gift card, a smartcard, a smart media, a payroll card, a health care card, a wrist band, a machine readable medium containing account information, a keychain device such as a SPEEDPASS® device commercially available from ExxonMobil Corporation or a supermarket discount card, a cellular phone, personal digital assistant, a pager, a security card, an access card, a wireless terminal, or a transponder. The portable consumer device 112 may include a volatile or non-volatile memory to store information such as the account number or an account holder's name.

Merchant 110 may use the POS terminal to obtain account information, such as an account number, from the portable consumer device 112. The portable consumer device 112 may interface with the POS terminal using a mechanism including any suitable electrical, magnetic, or optical interfacing system such as a contactless system using radio frequency or magnetic field recognition system or contact system such as a magnetic stripe reader. The POS terminal sends a transaction authorization request to the issuer 104 of the portable consumer device 112. Alternatively, or in combination, the portable consumer device 112 may communicate with issuer 104, transaction handler 106, or acquirer 108.

Issuer 104 may authorize the transaction using transaction handler 106. Transaction handler 106 may also clear the transaction. Authorization includes issuer 104, or transaction handler 106 on behalf of issuer 104, authorizing the transaction in connection with issuer 104's instructions such as through the use of business rules. The business rules could include instructions or guidelines from transaction handler 106, user 102, merchant 110, acquirer 108, issuer 104, a financial institution, or combinations thereof. Transaction handler 106 may maintain a log or history of authorized transactions. Once approved, merchant 110 will record the authorization, allowing user 102 to receive the good or service.

Merchant 110 may, at discrete periods, such as the end of the day, submit a list of authorized transactions to acquirer 108 or other components of the payment processing system 100. Transaction handler 106 may compare the submitted authorized transaction list with its own log of authorized transactions. If a match is found, transaction handler 106 may route authorization transaction amount requests from the corresponding acquirer 108 to the corresponding issuer 104 involved in each transaction. Once acquirer 108 receives the payment of the authorized transaction amount from issuer 104, it can forward the payment to merchant 110 less any transaction costs, such as fees. If the transaction involves a debit or pre-paid card, acquirer 108 may choose not to wait for the initial payment prior to paying merchant 110.

There may be intermittent steps in the foregoing process, some of which may occur simultaneously. For example, acquirer 108 can initiate the clearing and settling process, which can result in payment to acquirer 108 for the amount of the transaction. Acquirer 108 may request from transaction handler 106 that the transaction be cleared and settled. Clearing includes the exchange of financial information between the issuer 104 and the acquirer 108 and settlement includes the exchange of funds. Transaction handler 106 can provide services in connection with settlement of the transaction. The settlement of a transaction includes depositing an amount of the transaction settlement from a settlement house, such as a settlement bank, which transaction handler 106 typically chooses, into a clearinghouse, such as a clearing bank, that acquirer 108 typically chooses. Issuer 104 deposits the same from a clearinghouse, such as a clearing bank, which issuer 104 typically chooses, into the settlement house. Thus, a typical transaction involves various entities to request, authorize, and fulfill processing the transaction.

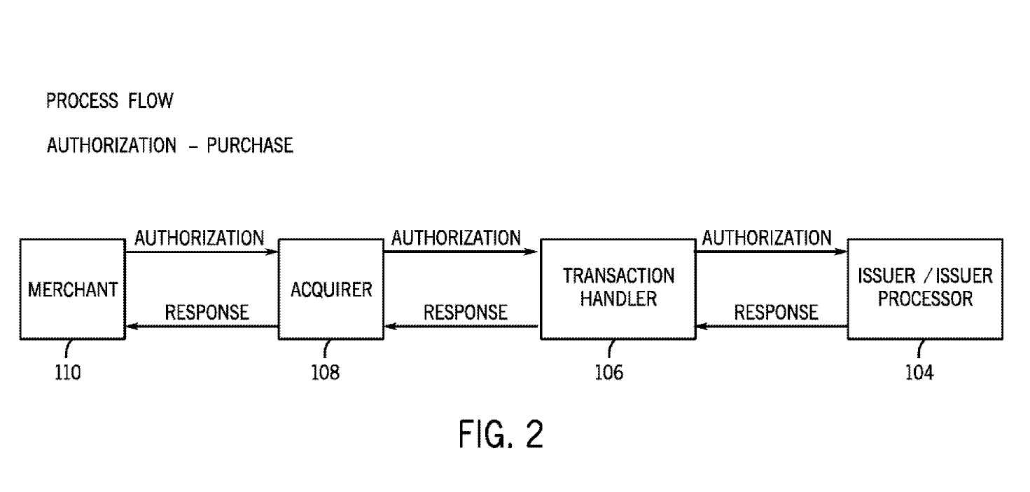

Implementations use the payment processing system described in FIG. 1 in a manner which accommodates the processing of private label portable consumer devices. By way of example and not by way of limitation, FIG. 2 illustrates an implementation of authorizing a purchase made with a private label portable consumer device in a payment processing system. As with major network labeled portable consumer devices, when merchant 110 and a consumer (not shown) engage in a transaction using a private label portable consumer device, merchant 110 sends an authorization request to acquirer 108, who then forwards the request on to transaction handler 106. Transaction handler 106 is in communication with issuer 104 and requests that issuer 104 approves of or denies the transaction. Transaction handler 106 then sends the response to the authorization request to the acquirer 108, who forwards it to merchant 110.

In one implementation, the authorization request from merchant 110 involves a transaction with a consumer for a good or service in exchange for payment. In other implementations, the transaction may be of a type, for example, that involves a coupon corresponding to a custom settlement agreement between merchant 110 and issuer 104, where the authorization request is for a validation of the coupon. In yet other implementations, the authorization request may be for a type of the transaction that involves a validation of a private label portable consumer device (i.e., the account to which device is associated) corresponding to a loyalty program or a warranty. Additional implementations may involve authorization requests that serve to check the activation status of a portable consumer device or the sufficiency of a consumer's credit line.

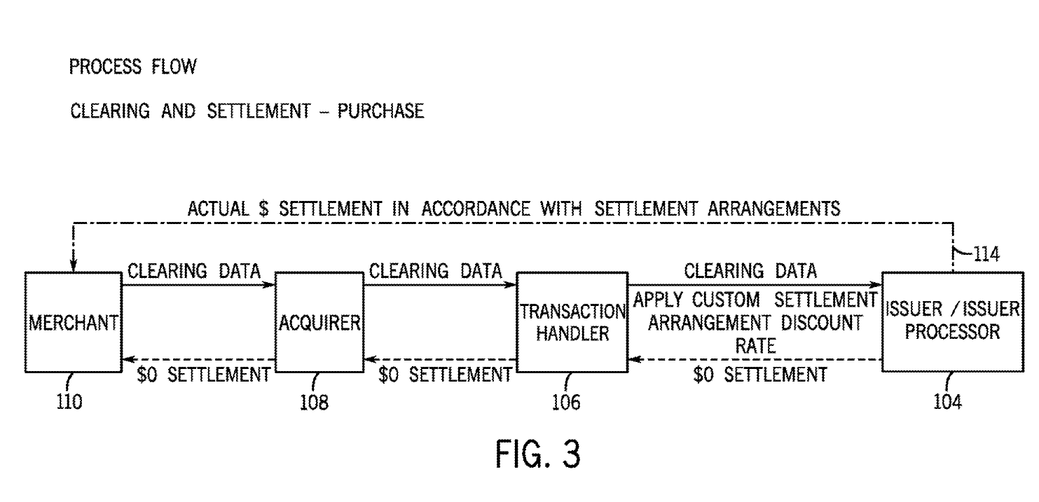

For authorization requests involving something other than the exchange of goods or services for payment, no clearing and settlement is needed and processing of the transaction ends. FIG. 3 illustrates an embodiment of a clearing and settlement process for a transaction involving the approval of payment for goods or services by a private label portable consumer device. For each transaction involving a payment that was approved, merchant 110 sends a settlement request to acquirer 108 who forwards it to transaction handler 106. Before requesting payment from issuer 104 for the transaction corresponding to the settlement request, transaction handler 106 uses a set of identifying criteria to determine if the transaction involved a private label portable consumer device. By way of example, and not by way of limitation, such criteria may be a bank identification number, card or account number range, merchant verification value (MVV), transaction amount, merchant location, Stock-Keeping Unit (SKU) data, other characteristics of the transaction, or a combination thereof. In one embodiment, the identifying criteria is provided to transaction handler 106 from issuer 104 and further corresponds to a custom settlement arrangement between merchant 110 and issuer 104.

Upon determining that the transaction meets the criteria and therefore involves a private label portable consumer device, transaction handler 106 applies a custom arrangement rate to the payment requested. In one implementation, the issuer provides the custom arrangement rate to transaction handler 106, where the custom arrangement rate corresponds to a specific custom settlement arrangement. Alternatively, the custom arrangement rate may be a standard rate applied by transaction handler 106 to all transactions involving a private label portable consumer device, regardless of whether the individual merchant and issuer had any custom settlement arrangements. In one implementation, the custom arrangement rate is one-hundred percent (100%) of the payment requested in the settlement request, thereby resulting in a settlement amount of zero such that the transaction handler 106 neither (i) debits the account issued by the issuer 104 upon which the transaction was conducted nor (ii) credits the account held by the acquirer 106 for the merchant with whom the transaction was conducted. In yet another implementation, the custom arrangement rate is less than one-hundred percent (100%), resulting in some amount less than the total purchase amount that is debited from issuer 104 and credited to acquirer 108 to be forwarded to merchant 110.

Transaction handler 106 processes settlement requests from multiple merchants to a variety of issuers. In one implementation, the criteria and associated custom arrangement rate may be the same for all custom settlement agreements. In yet another implementation, transaction handler 106 stores the criteria and associated custom arrangement rate in, for example, a database or a table having multiple sets of criteria and custom arrangement rates corresponding to custom settlement agreements between different merchants 110 and issuers 104, where the transaction data is compared against each criteria in the database until a match is found.

In yet another implementation, the custom arrangement payment amount equals the total payment amount owed to merchant 110 for a transaction involving a private label portable consumer device. If, however, there exists a remaining balance owed to merchant 110, merchant 110, being in communication with issuer 104 outside of the payment processing network (illustrated as dashed line 114), sends a request to issuer 104 for settlement in accordance with the custom settlement agreement between them. Issuer 104 then directly makes the appropriate payment to merchant 110 without processing by transaction handler 106 and acquirer 108.

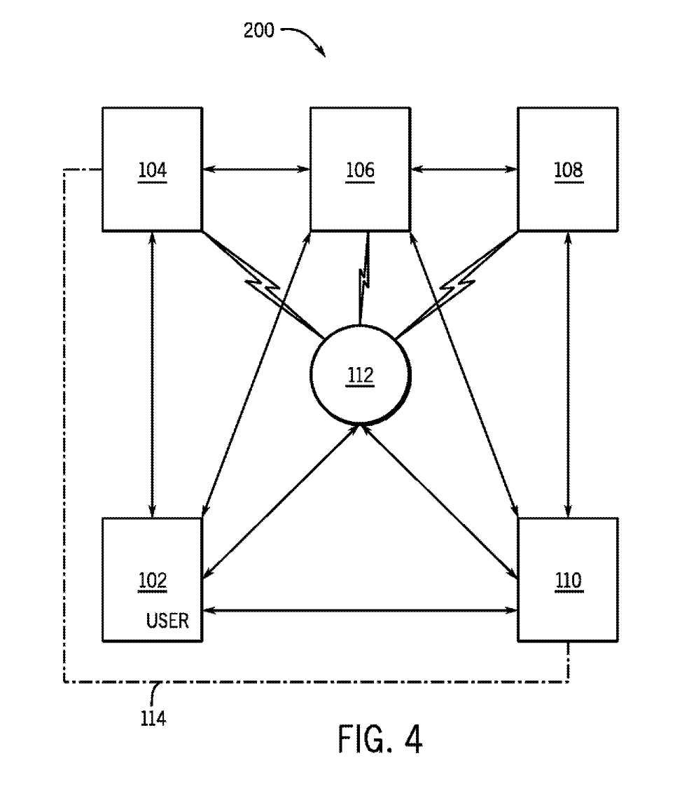

FIG. 4 illustrates an exemplary payment processing system capable of processing private label portable consumer devices in the manner illustrated in FIG. 3 as described above. As with the payment processing system 100 of FIG. 1, payment processing system 200 includes an user 102, a transaction handler 106, an acquirer 108, a merchant 110, and an issuer 104. The acquirer 108 and the issuer 104 communicate through the transaction handler 106, as with payment processing system 100.

A transaction is initiated by user 102, presenting a portable consumer device 112 to merchant 110, where the portable consumer device 112 is a private label portable consumer device. The merchant 110 may use its POS to obtain account information from the portable consumer device 112. Alternatively, or in combination, the portable consumer device 112 may communicate with issuer 104, transaction handler 106, or acquirer 108.

Issuer 104 authorizes the transaction using transaction handler 106, where the authorization includes the issuer 104, or the transaction handler 106 on behalf of the issuer 104, authorizing the transaction in connection with the issuer 104's instructions. Once approved, merchant 110 records the authorization.

For authorized transactions involving a payment to merchant 110, merchant 110, at discrete periods, submit the authorized transactions as settlement requests to acquirer 108 to be forwarded to transaction handler 106. For each such settlement request, transaction handler 106 determines whether a private label portable consumer device was involved in the transaction by comparing the transaction information with predetermined criteria. If there is a match, transaction handler 106 applies a corresponding custom arrangement rate to the payment amount sought to derive an applied payment amount and forwards a request for the applied payment amount to issuer 104. Upon receiving the applied payment amount from issuer 104, transaction handler 106 forwards the applied payment amount to acquirer 108, who forwards it to merchant 110. No custom arrangement rate is applied where the transaction information does not meet the predefined criteria and, thus, the clearing and settlement process for such authorized transactions continue as discussed in connection with FIG. 1.

Where the applied payment received by merchant 110 is less than the amount owed to merchant 110 for the authorized transaction, merchant 110, being in direct communication with issuer 104 (as shown by dashed line 114), requests that the issuer 104 settle the approved transaction in accordance with the custom settlement agreement.

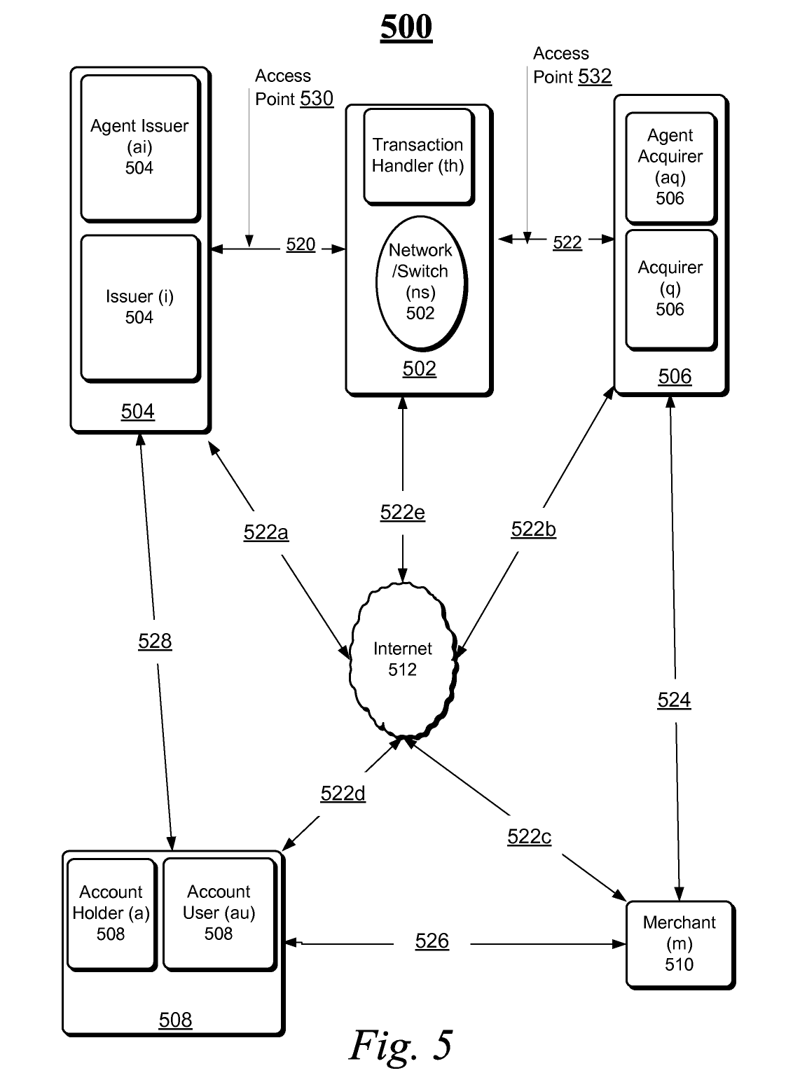

Referring to FIG. 5, a transaction processing system 500 is seen. The general environment of FIG. 5 include that of a merchant (m) 510, such as the merchant, who can conduct a transaction for goods and/or services with an account user (au) (e.g., consumer) on an account issued to an account holder (a) 508 by an issuer (i) 504, where the processes of paying and being paid for the transaction are coordinated by at least one transaction handler (th) 502 (e.g., the transaction handler) (collectively “users”). The transaction includes participation from different entities that are each a component of the transaction processing system 500.

The transaction processing system 500 may have at least one of a plurality of transaction handlers (th) 502 that includes transaction handler (1) 502 through transaction handler (TH) 502, where TH can be up to and greater than an eight digit integer.

The transaction processing system 500 has a plurality of merchants (m) 510 that includes merchant (1) 510 through merchant (M) 510, where M can be up to and greater than an eight digit integer. Merchant (m) 510 may be a person or entity that sells goods and/or services. Merchant (m) 510 may also be, for instance, a manufacturer, a distributor, a retailer, a load agent, a drugstore, a grocery store, a gas station, a hardware store, a supermarket, a boutique, a restaurant, or a doctor's office. In a business-to-business setting, the account holder (a) 508 may be a second merchant (m) 510 making a purchase from another merchant (m) 510.

Transaction processing system 500 includes account user (1) 508 through account user (AU) 508, where AU can be as large as a ten digit integer or larger. Each account user (au) conducts a transaction with merchant (m) 510 for goods and/or services using the account that has been issued by an issuer (i) 504 to a corresponding account holder (a) 508. Data from the transaction on the account is collected by the merchant (m) 510 and forwarded to a corresponding acquirer (a) 506. Acquirer (a) 506 forwards the data to transaction handler (th) 502 who facilitates payment for the transaction from the account issued by the issuer (i) 504 to account holder (a) 508.

Transaction processing system 500 has a plurality of acquirers (q) 506. Each acquirer (q) 506 may be assisted in processing one or more transactions by a corresponding agent acquirer (aq) 506, where ‘q’ can be an integer from 1 to Q, where aq can be an integer from 1 to AQ, and where Q and AQ can be as large as a eight digit integer or larger. Each acquirer (q) 506 may be assisted in processing one or more transactions by a corresponding agent acquirer (aq) 506, where ‘q’ can be an integer from 1 to Q, where aq can be an integer from 1 to AQ, and where Q and AQ can be as large as a eight digit integer or larger.

The transaction handler (th) 502 may process a plurality of transactions within the transaction processing system 500. The transaction handler (th) 502 can include one or a plurality or networks and switches (ns) 502. Each network/switch (ns) 502 can be a mainframe computer in a geographic location different than each other network/switch (ns) 502, where ‘ns’ is an integer from one to NS, and where NS can be as large as a four digit integer or larger.

Dedicated communication systems 520, 522 (e.g., private communication network(s)) facilitate communication between the transaction handler (th) 502 and each issuer (i) 504 and each acquirer (a) 506. A Network 512, via e-mail, the World Wide Web, cellular telephony, and/or other optionally public and private communications systems, can facilitate communications 522a-522e among and between each issuer (i) 504, each acquirer (a) 506, each merchant (m) 510, each account holder (a) 508, and the transaction handler (th) 502. Alternatively and optionally, one or more dedicated communication systems 524, 526, and 528 can facilitate respective communications between each acquirer (a) 506 and each merchant (m) 510, each merchant (m) and each account holder (a) 508, and each account holder (a) 508 and each issuer (i) 504, respectively.

The Network 512 may represent any of a variety of suitable means for exchanging data, such as: an Internet, an intranet, an extranet, a wide area network (WAN), a local area network (LAN), a virtual private network, a satellite communications network, an Automatic Teller Machine (ATM) network, an interactive television network, or any combination of the forgoing. Network 512 may contain either or both wired and wireless connections for the transmission of signals including electrical, magnetic, and a combination thereof. Examples of such connections are known in the art and include: radio frequency connections, optical connections, etc. To illustrate, the connection for the transmission of signals may be a telephone link, a Digital Subscriber Line, or cable link. Moreover, network 512 may utilize any of a variety of communication protocols, such as Transmission Control Protocol/Internet Protocol (TCP/IP), for example. There may be multiple nodes within the network 512, each of which may conduct some level of processing on the data transmitted within the transaction processing system 500.

Users of the transaction processing system 500 may interact with one another or receive data about one another within the transaction processing system 500 using any of a variety of communication devices. The communication device may have a processing unit operatively connected to a display and memory such as Random Access Memory (“RAM”) and/or Read-Only Memory (“ROM”). The communication device may be combination of hardware and software that enables an input device such as a keyboard, a mouse, a stylus and touch screen, or the like.

For example, use of the transaction processing system 500 by the account holder (a) 508 may include the use of a portable consumer device (PCD). The PCD may be one of the communication devices, or may be used in conjunction with, or as part of, the communication device. The PCD may be in a form factor that can be: a card (e.g., bank card, payment card, financial card, credit card, charge card, debit card, gift card, transit pass, smart card, access card, a payroll card, security card, healthcare card, or telephone card), a tag, a wristwatch, wrist band, a key ring, a fob (e.g., SPEEDPASS® commercially available from ExxonMobil Corporation), a machine readable medium containing account information, a pager, a cellular telephone, a personal digital assistant, a digital audio player, a computer (e.g., laptop computer), a set-top box, a portable workstation, a minicomputer, or a combination thereof. The PCD may have near field or far field communication capabilities (e.g., satellite communication or communication to cell sites of a cellular network) for telephony or data transfer such as communication with a global positioning system (GPS). The PCD may support a number of services such as SMS for text messaging and Multimedia Messaging Service (MMS) for transfer of photographs and videos, electronic mail (email) access.

The PCD may include a computer readable medium. The computer readable medium, such as a magnetic stripe or a memory of a chip or a chipset, may include a volatile, a non-volatile, a read only, or a programmable memory that stores data, such as an account identifier, a consumer identifier, and/or an expiration date. The computer readable medium may including executable instructions that, when executed by a computer, the computer will perform a method. For example, the computer readable memory may include information such as the account number or an account holder (a) 508's name.

Examples of the PCD with memory and executable instructions include: a smart card, a personal digital assistant, a digital audio player, a cellular telephone, a personal computer, or a combination thereof. To illustrate, the PCD may be a financial card that can be used by a consumer to conduct a contactless transaction with a merchant, where the financial card includes a microprocessor, a programmable memory, and a transponder (e.g., transmitter or receiver). The financial card can have near field communication capabilities, such as by one or more radio frequency communications such as are used in a “Blue Tooth” communication wireless protocol for exchanging data over short distances from fixed and mobile devices, thereby creating personal area networks.

Merchant (m) 510 may utilize at least one POI terminal (e.g., Point of Service or browser enabled consumer cellular telephone); that can communicate with the account user (au) 508, the acquirer (a) 506, the transaction handler (th) 502, or the issuer (i) 504. A Point of Interaction (POI) can be a physical or virtual communication vehicle that provides the opportunity, through any channel to engage with the consumer for the purposes of providing content, messaging or other communication, related directly or indirectly to the facilitation or execution of a transaction between the merchant (m) 510 and the consumer. Examples of the POI include: a physical or virtual Point of Service (POS) terminal, the PCD of the consumer, a portable digital assistant, a cellular telephone, paper mail, e-mail, an Internet website rendered via a browser executing on computing device, or a combination of the forgoing. Thus, the POI terminal is in operative communication with the transaction processing system 500.

The PCD may interface with the POI using a mechanism including any suitable electrical, magnetic, or optical interfacing system such as a contactless system using radio frequency, a magnetic field recognition system, or a contact system such as a magnetic stripe reader. To illustrate, the POI may have a magnetic stripe reader that makes contact with the magnetic stripe of a healthcare card (e.g., Flexible Savings Account card) of the consumer. As such, data encoded in the magnetic stripe on the healthcare card of consumer read and passed to the POI at merchant (m) 510. These data can include an account identifier of a healthcare account. In another example, the POI may be the PCD of the consumer, such as the cellular telephone of the consumer, where the merchant (m) 510, or an agent thereof, receives the account identifier of the consumer via a webpage of an interactive website rendered by a browser executing on a World Wide Web (Web) enabled PCD.

Typically, a transaction begins with account user (au) 508 presenting the portable consumer device to the merchant (m) 510 to initiate an exchange for resources (e.g., a good or service). The portable consumer device may be associated with an account (e.g., a credit account) of account holder (a) 508 that was issued to the account holder (a) 508 by issuer (i) 504.

Merchant (m) 510 may use the POI terminal to obtain account information, such as a number of the account of the account holder (a) 508, from the portable consumer device. The portable consumer device may interface with the POI terminal using a mechanism including any suitable electrical, magnetic, or optical interfacing system such as a contactless system using radio frequency or magnetic field recognition system or contact system such as a magnetic stripe reader. The POI terminal sends a transaction authorization request to the issuer (i) 504 of the account associated with the PCD. Alternatively, or in combination, the PCD may communicate with issuer (i) 504, transaction handler (th) 502, or acquirer (a) 506.

Issuer (i) 504 may authorize the transaction and forward same to the transaction handler (th) 502. Transaction handler (th) 502 may also clear the transaction. Authorization includes issuer (i) 504, or transaction handler (th) 502 on behalf of issuer (i) 504, authorizing the transaction in connection with issuer (i) 504's instructions such as through the use of business rules. The business rules could include instructions or guidelines from the transaction handler (th) 502, the account holder (a) 508, the merchant (m) 510, the acquirer (a) 506, the issuer (i) 504, a related financial institution, or combinations thereof. The transaction handler (th) 502 may, but need not, maintain a log or history of authorized transactions. Once approved, the merchant (m) 510 may record the authorization, allowing the account user (au) 508 to receive the good or service from merchant (m) or an agent thereof.

The merchant (m) 510 may, at discrete periods, such as the end of the day, submit a list of authorized transactions to the acquirer (a) 506 or other transaction related data for processing through the transaction processing system 500. The transaction handler (th) 502 may optionally compare the submitted authorized transaction list with its own log of authorized transactions. The transaction handler (th) 502 may route authorization transaction amount requests from the corresponding the acquirer (a) 506 to the corresponding issuer (i) 504 involved in each transaction. Once the acquirer (a) 506 receives the payment of the authorized transaction from the issuer (i) 504, the acquirer (a) 506 can forward the payment to the merchant (m) 510 less any transaction costs, such as fees for the processing of the transaction. If the transaction involves a debit or pre-paid card, the acquirer (a) 506 may choose not to wait for the issuer (i) 504 to forward the payment prior to paying merchant (m) 510.

There may be intermittent steps in the foregoing process, some of which may occur simultaneously. For example, the acquirer (a) 506 can initiate the clearing and settling process, which can result in payment to the acquirer (a) 506 for the amount of the transaction. The acquirer (a) 506 may request from the transaction handler (th) 502 that the transaction be cleared and settled. Clearing includes the exchange of financial information between the issuer (i) 504 and the acquirer (a) 506 and settlement includes the exchange of funds. The transaction handler (th) 502 can provide services in connection with settlement of the transaction. The settlement of a transaction includes depositing an amount of the transaction settlement from a settlement house, such as a settlement bank, which transaction handler (th) 502 typically chooses, into a clearinghouse bank, such as a clearing bank, that acquirer (a) 506 typically chooses. The issuer (i) 504 deposits the same from a clearinghouse bank, such as a clearing bank, which the issuer (i) 504 typically chooses, into the settlement house. Thus, a typical transaction involves various entities to request, authorize, and fulfill processing the transaction.

The transaction processing system 500 will preferably have network components suitable for scaling the number and data payload size of transactions that can be authorized, cleared and settled in both real time and batch processing. These include hardware, software, data elements, and storage network devices for the same. Examples of transaction processing system 500 include those operated, at least in part, by: American Express Travel Related Services Company, Inc; MasterCard International, Inc.; Discover Financial Services, Inc.; First Data Corporation; Diners Club International, LTD; Visa Inc.; and agents of the foregoing.

Each of the network/switch (ns) 502 can include one or more data centers for processing transactions, where each transaction can include up to 50 kilobytes of data or more. The data corresponding to the transaction can include information about the types and quantities of goods and services in the transaction, information about the account holder (a) 508, the account user (au) 508, the merchant (m) 510, tax and incentive treatment(s) of the goods and services, coupons, rebates, rewards, loyalty, discounts, returns, exchanges, cash-back transactions, etc.

By way of example, network/switch (ns) 502 can include one or more mainframe computers (e.g., one or more IBM mainframe computers) for one or more server farms (e.g., one or more Sun UNIX Super servers), where the mainframe computers and server farms can be in diverse geographic locations.

Each issuer (i) 504 (or agent issuer (ai) 504 thereof) and each acquirer (a) 506 (or agent acquirer (aq) 506 thereof) can use or more router/switch (e.g., Cisco™ routers/switches) to communicate with each network/switch (ns) 502 via dedicated communication systems.

FIG. 5 includes one or more transaction handlers transaction handler (th) 502 and access points 530, 532. Other entities such as drawee banks and third party authorizing agents may also connect to the network through an access point. An interchange center is a data processing center that may be located anywhere in the world. In one embodiment, there are two in the United States and one each in the United Kingdom and in Japan. Each interchange center houses the computer system that performs the network transaction processing. The interchange center serves as the control point for the telecommunication facilities of the network, which comprise high speed leased lines or satellite connections based on IBM SNA protocol. Preferable, the communication lines that connect an interchange center (transaction handlers 202, 1406) to remote entities use dedicated high-bandwidth telephone circuits or satellite connections based on the IBM SNA-LU0 communication protocol. Messages are sent over these lines using any suitable implementation of the ISO 8583 standard.

Access points 530, 532 are typically made up of small computer systems located at a processing center that interfaces between the center's host computer and the interchange center The access point facilitates the transmission of messages and files between the host and the interchange center supporting the authorization, clearing and settlement of transaction. Telecommunication links between the acquirer (q) 506 and its access point, and between the access point and issuer (i) 504 are typically local links within a center and use a proprietary message format as preferred by the center.

A data processing center (such as is located within an acquirer, issuer, or other entity) houses processing systems that support merchant and business locations and maintains customer data and billing systems. Preferably, each processing center is linked to one or two interchange centers. Processors are connected to the closest interchange, and if the network experiences interruptions, the network automatically routes transactions to a secondary interchange center. Each interchange center is also linked to all of the other interchange centers. This linking enables processing centers to communicate with each other through one or more interchange centers. Also, processing centers can access the networks of other programs through the interchange center. Further, the network ensures that all links have multiple backups. The connection from one point of the network to another is not usually a fixed link; instead, the interchange center chooses the best possible path at the time of any given transmission. Rerouting around any faulty link occurs automatically.

Transaction handler (th) 502 can store information about transactions processed through transaction processing system 500 in data warehouses such as may be incorporated as part of the plurality of networks/switches 502. This information can be data mined. The data mining transaction research and modeling can be used for advertising, account holder and merchant loyalty incentives and rewards, fraud detection and prediction, and to develop tools to demonstrate savings and efficiencies made possible by use of the transaction processing system 500 over paying and being paid by cash, or other traditional payment mechanisms.

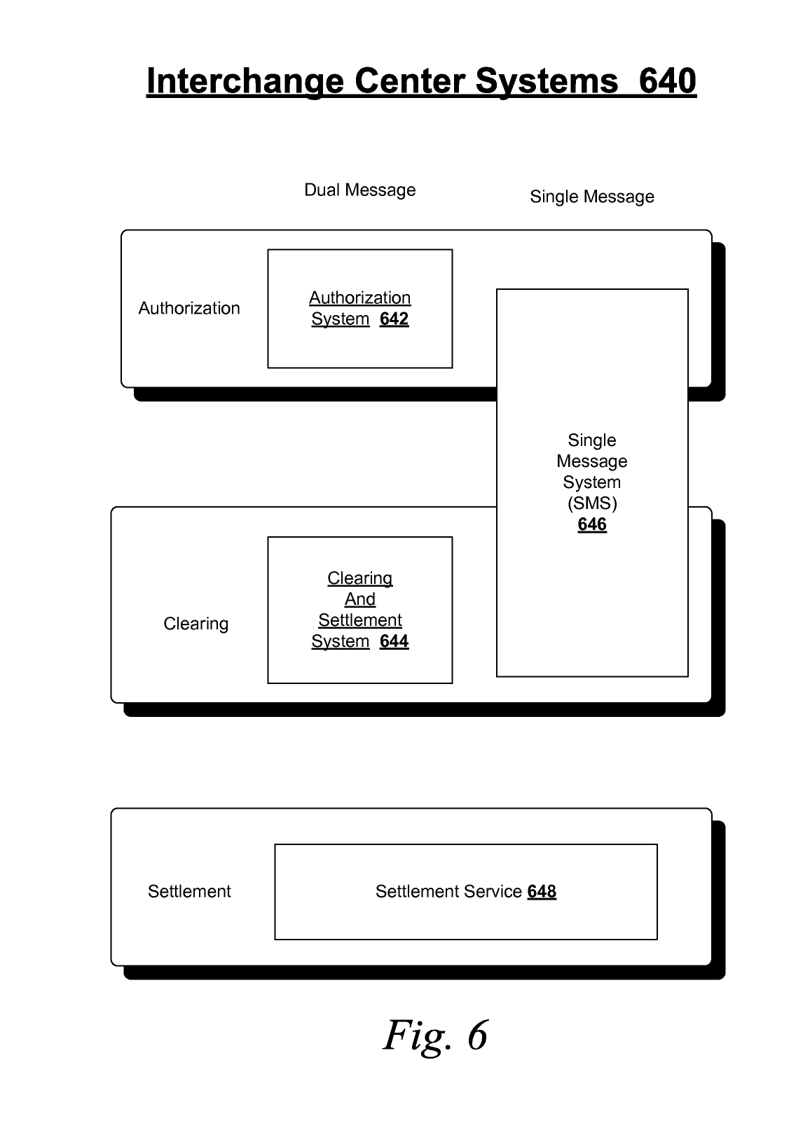

FIG. 6 illustrates systems 640 housed within an interchange center to provide on-line and off-line transaction processing. For dual message transaction, authorization system 642 provides authorization. System 642 supports on-line and off-line functions, and its file includes internal systems tables, a customer database and a merchant central file. The on-line functions of system 642 support dual message authorization processing. This processing involves routing, cardholder and card verification and stand-in processing, and other functions such as file maintenance. Off-line functions including reporting, billing, and generating recovery bulletins. Reporting includes authorization reports, exception file and advice file reports, POS reports and billing reports. A bridge from system 642 to system 646 makes it possible for members using system 642 to communicate with members using system 646 and access the SMS gateways to outside networks.

Clearing and settlement system 644 clears and settles previously authorized dual message transactions. Operating six days a week on a global basis, system 644 collects financial and non-financial information and distributes reports between members It also calculates fees, charges and settlement totals and produces reports to help with reconciliation. A bridge forms an interchange between system 644 processing centers and system 646 processing centers.

Single message system 646 processes full financial transactions. System 646 can also process dual message authorization and clearing transactions, and communicates with system 642 using a bridge and accesses outside networks as required. System 646 processes Visa, Plus Interlink and other card transactions. The SMS files comprise internal system tables that control system access and processing, and the cardholder database, which contains files of cardholder data used for PIN verification and stand-in processing authorization. System 646 on-line functions perform real-time cardholder transaction processing and exception processing for authorization as well as full financial transactions. System 646 also accumulates reconciliation and settlement totals. System 646 off-line functions process settlement and funds transfer requests and provide settlement and activities reporting. Settlement service 648 consolidates the settlement functions of system 644 and 646, including Interlink, into a single service for all products and services. Clearing continues to be performed separately by system 644 and system 646.

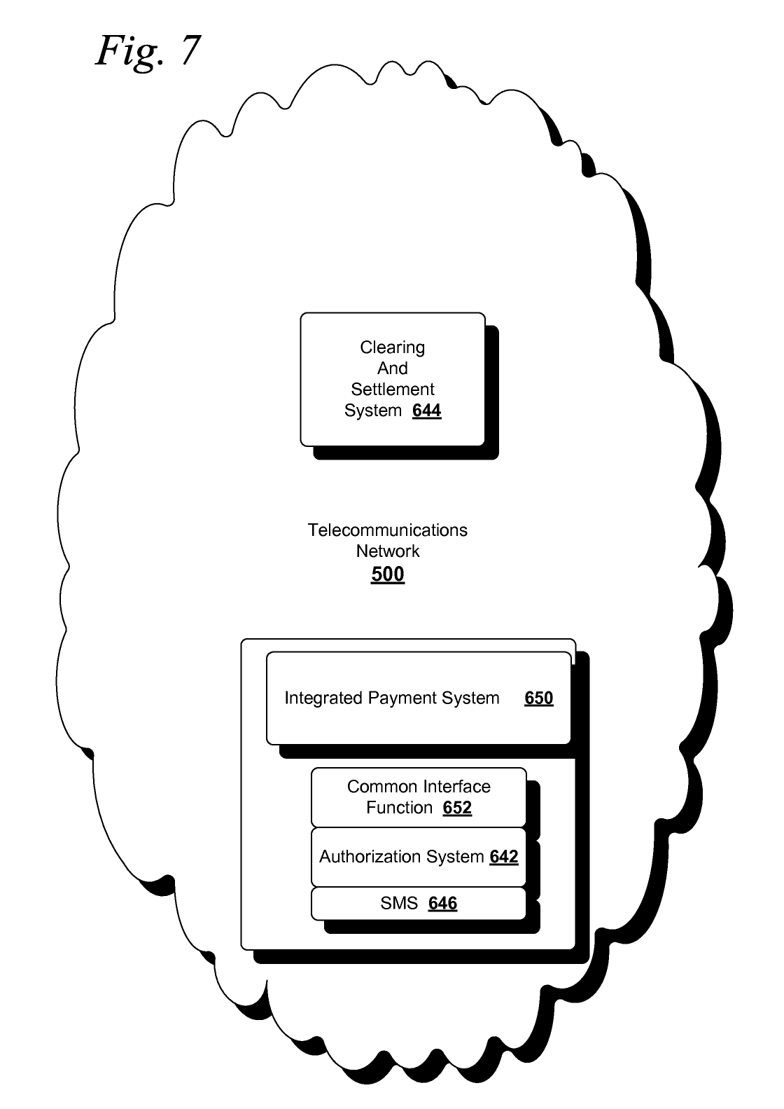

FIG. 7 illustrates another view of components of FIG. 5 as a telecommunications network 500. Integrated payment system 650 is the primary system for processing all on-line authorization and financial request transactions. System 650 reports both dual message and single message processing. In both cases, settlement occurs separately. The three main software components are the common interface function 652, authorization system 642 and single message system 646.

Common interface function 652 determines the processing required for each message received at an interchange center. It chooses the appropriate routing, based on the source of the message (system 642, 644 or 646), the type of processing request and the processing network. This component performs initial message editing, and, when necessary, parses the message and ensures that the content complies with basic message construction rules. Common interface function 652 routes messages to their system 642 or system 646 destinations.

The VisaNet® system is an example component of the transaction handler (th) 502 in the transaction processing system 500. Presently, the VisaNet® system is operated in part by Visa Inc. As of 2006, the VisaNet® system Inc. was processing around 300 million transaction daily, on over 1 billion accounts used in over 170 countries. Financial instructions numbering over 16,000 connected through the VisaNet® system to around 30 million merchants (m) 610. In 2007, around 71 billion transactions for about 4 trillion U.S. dollars were cleared and settled through the VisaNet® system, some of which involved a communication length of around 24,000 miles in around two (2) seconds and during which a plurality of stops are made for processing data in the transaction.

The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods for various implements. Moreover, it is understood that a functional step of described methods or processes, and combinations thereof can be implemented by computer program instructions that, when executed by a processor, create means for implementing the functional steps. The instructions may be included in computer readable medium that can be loaded onto a general purpose computer, a special purpose computer, or other programmable apparatus.

It is understood that the examples and implementations described herein are for illustrative purposes only and that various modifications or changes in light thereof will be suggested to persons skilled in the art and are to be included within the spirit and purview of this application and scope of the appended claims.

What is claimed is:

1. A method comprising a plurality of steps each being performed by hardware executing software, wherein the steps include:
receiving an authorization request for a transaction in a payment processing network;
addressing a first transmission for delivery, the first transmission including an authorization response either denying or approving the transaction;
receiving, when the first transmission includes the authorization response approving the transaction, a settlement request for the transaction;
applying, when the settlement request for the transaction is received and the transaction meets a criteria set in a custom settlement arrangements table, a custom settlement arrangement rate to the settlement request; and
addressing, when the custom settlement arrangement rate is applied to the settlement request, a second transmission for delivery, the second transmission including a settlement response to the applied settlement request.

2. The method as defined in claim 1, wherein the custom settlement arrangement table comprises other said criteria respectively corresponding to other said custom settlement arrangement rates.

3. The method as defined in claim 1, wherein the criteria set in the custom settlement arrangements table is received from an issuer of a payment device involved in the transaction.

4. The method as defined in claim 3, wherein the custom settlement arrangement rate corresponding to the criteria set in the custom settlement arrangements table is received from the issuer of the payment device involved in the transaction.

5. The method as defined in claim 1, wherein:
the settlement request includes a transaction amount; and
the settlement response includes a custom settlement amount that is different from the transaction amount.

6. The method as defined in claim 1, wherein the criteria is selected from the group consisting of:
a Bank Identification Number (BIN);
a card or account number range;
a Merchant Verification Value (MVV);
a transaction amount;
a merchant location; and
a Stock-Keeping Unit (SKU) data.

7. The method as defined in claim 1, wherein the authorization request for the transaction includes at least one of:
a coupon;
a loyalty program;
a credit line check;
a warranty; and
an activation status.

8. A method comprising a plurality of steps each being performed by hardware executing software, wherein the steps include:
receiving an authorization request for a transaction in a payment processing network;
addressing a first transmission for delivery, the first transmission including an authorization response either denying or approving the transaction;
receiving, when the first transmission includes the authorization response approving the transaction, a settlement request for the transaction, the settlement request including a transaction amount;
determining, when the settlement request for the transaction is received and the transaction meets a criteria set in a custom settlement arrangements table, a custom settlement amount by applying a custom settlement arrangement rate to the transaction amount;
debiting, when the custom settlement amount is determined, an issuer the custom settlement amount; and
addressing, when the custom settlement amount is debited, a second transmission for delivery to an acquirer, the second transmission including a credit for the custom settlement amount.

9. The method as defined in claim 8, wherein the custom settlement arrangement table comprises other said criteria respectively corresponding to other said custom settlement arrangement rates.

10. The method as defined in claim 8, wherein the criteria set in the custom settlement arrangements table is received from the issuer.

11. The method as defined in claim 10, wherein the custom settlement arrangement rate corresponding to the criteria set in the custom settlement arrangements table is received from the issuer.

12. The method as defined in claim 8, wherein the criteria is at least one member of the group consisting of:
a bank identification number;
a card range;
a Merchant Verification Value (MVV);
a transaction amount;
a merchant location; and
a Stock-Keeping Unit (SKU).

13. The method as defined in claim 8, wherein the authorization request for the transaction includes at least one of:
a coupon;
a loyalty program;
a credit line check;
a warranty; and
an activation status.

14. A method comprising a plurality of steps each being performed by hardware executing software, wherein the steps include:
receiving, from an issuer, a criteria for applying a custom settlement arrangement rate to a transaction;
storing the criteria and the custom settlement arrangement rate in a custom settlement arrangement table containing other said criteria corresponding to other said custom settlement arrangement rates;
receiving an authorization request for a transaction in a payment processing network;
addressing a first transmission for delivery, the first transmission including an authorization reply either denying or approving the transaction;
receiving, when the first transmission includes the authorization response approving the transaction, a settlement request for the transaction, the settlement request comprising transaction data and a transaction amount;
applying, when the settlement request for the transaction is received and the transaction data meets the criteria after being compared to said criteria in the custom settlement arrangement table, the custom settlement arrangement rate to the transaction amount; and
addressing, when the settlement request for the transaction is received, a second transmission for delivery, the second transmission including a settlement response to the transaction.

15. The method as defined in claim 14, wherein the custom settlement arrangement table comprises other said criteria respectively corresponding to other said custom settlement arrangement rates.

16. The method as defined in claim 14, wherein the settlement response includes a custom settlement amount that is different from the transaction amount.

17. A method comprising a plurality of steps each being performed by hardware executing software, wherein the steps include:
addressing a first transmission for delivery, the first transmission including an authorization request for a transaction in a payment processing network;
receiving an authorization response to the authorization request, the authorization response either denying or approving the transaction;
addressing, when the authorization response approves the transaction, a second transmission for delivery, the second transmission including a settlement request for the transaction; and
receiving, when the second transmission includes a settlement request for the transaction and the transaction meets a criteria set in a custom settlement arrangements table, a settlement response to the settlement request, wherein a custom settlement arrangement rate is applied to the settlement request.

18. The method as defined in claim 17, wherein the custom settlement arrangement table comprises other said criteria respectively corresponding to other said custom settlement arrangement rates.

19. The method as defined in claim 17, wherein the criteria and the custom settlement arrangement rate is set by an issuer of a payment device involved in the transaction.

20. The method as defined in claim 17, wherein
the settlement request includes a transaction amount; and
the settlement response includes a custom settlement amount that is different from the transaction amount.

21. A payment processing apparatus wherein a transaction handler processes, by hardware executing software, a plurality of transactions each characterized by a merchant and a consumer engaging in the transaction upon an account associated by a payment device that an issuer issues to the consumer, the payment processing apparatus comprising:
an open loop network, wherein the merchant submits the transaction to an acquirer to submit the transaction for processing by the transaction handler who requests the issuer to obtain payment for the transaction, and wherein the issuer forwards the payment to the transaction handler who forwards the payment to the acquirer to pay the merchant for the transaction;
and
a closed loop network, wherein the merchant submits a settlement request to the issuer requesting the issuer obtain payment for the transaction and wherein the issuer forwards the payment for the transaction to the merchant, the merchant and issuer having a custom settlement arrangement wherein at least one condition for payment of the transaction is defined, wherein:
when the merchant submits said transaction to the open loop network and the transaction meets a predetermined criteria:
the transaction handler applies a custom arrangement rate to said payment to derive an applied payment;
the transaction handler requests the issuer to obtain said applied payment; and
the issuer forwards the applied payment to the transaction handler who forwards the applied payment to the acquirer to pay the merchant for said transaction; and
when said transaction meets the at least one condition, the merchant submits the settlement request to the issuer to obtain a remainder payment for the transaction equal to the payment less the applied payment.

22. The system as defined in claim 21, wherein the custom settlement arrangement table comprises other said criteria respectively corresponding to other said custom settlement arrangement rates.

23. The system as defined in claim 21 wherein the criteria and the custom arrangement rate is received by the transaction handler from the issuer.

24. The system as defined in claim 21, wherein the criteria is at least one member of the group consisting of:
a bank identification number;
a card range;
a Merchant Verification Value (MVV);
a transaction amount;
a merchant location; and
a Stock-Keeping Unit (SKU).

25. The system as defined in claim 21, wherein the transaction includes a member from the group consisting of:
a coupon;
a loyalty program;
a credit line check;
a warranty; and
an activation status.
